(19) United States
(12) Patent Application Publication
(10) Pub. No.: US 2022/0374798 A1
(43) Pub. Date: Nov. 24, 2022

(54) Software as Venture Capital

(71) Applicant: Ian Sharp, Dania Beach, FL (US)

(72) Inventor: Ian Sharp, Dania Beach, FL (US)

(21) Appl. No.: 17/328,131

(22) Filed: May 24, 2021

(51) Int. Cl. G06Q 10/06; G06Q 40/06

(52) U.S. Cl. CPC G06Q 10/0637; G06Q 40/06

(57) ABSTRACT

Venture capital is not what software company startups require to create a software company. Software is what is required. This business method patent outlines how software can be used as capital in the place of and replacing the use of cash as capital for software startup companies. This business method invention also depicts a strategy for how single contributor software engineers can diversify their contributions as investments in several technological startup ventures, whereas until now software engineers have been limited to being sole contributors. This business method has the intended outcome of also increasing the rate at which a new software company can be brought to market and sold.

### STATEMENT REGARDING FEDERALLY SPONSORED RESEARCH OR DEVELOPMENT

No federal funds were used for this research or development

### BACKGROUND OF THE INVENTION

This is a business method patent invented by Ian Sharp PhD. This business method patent solves two major challenges in the software venture capital space across the enterprise.

The first challenge solved is for non-technical software entrepreneurs who aim to create a technology company. The problem for non-technical founders of software companies is having software to sell. They could have access to capital as cash from investors, or they might not, but cash does not solve the problem if only for a short period of time. In other words investment does not solve the challenge of having software, because the non-technical founder always needs more cash. Founders understand very well that they have this problem, a certain amount of runway from capital, or else an end to their company, or alternatively the company never starts at all. Ideally the founder would like to make a public offering, or make a return on investment to make their sacrifice and opportunity cost of lost earnings worth the venture.

The second challenge is for software engineers. Typically over-worked with the promise of some equity within the company, they too are hoping for a public offering, or a return on investment for the additional unpaid hours they have invested into the single company they are working for.

To better illustrate the challenge of software engineers it would first be better to juxtapose their limitations with the success of what is known as the typical venture capital firm today. Venture capital firms know that the majority of companies they invest in will not succeed at all, fewer will break even, and they are betting on just a few companies making a big return on investment for them. Returns can be measured in any kind of cash flow, royalty, stock option, etc. The point is, venture capital firms can diversify their investments in several companies and hope they make a return on investment. Venture capital providers do not spend much time with the business because they have one main function, to provide money, which does not cost time. The extra time is then used to diversify in other companies.

Software engineers on the other hand, until now, have been limited investing all of their resources into a single software company. This investment takes 100% of their time, because their contribution is creating software. This method has a limited ability to provide returns, because when looking at the numbers if only 1 in 10,000 software companies are successful, the software engineer would need to live thousands of lifetimes before working for a successful company that made their extra sacrifice worth it.

If the software engineer could diversify their contributions across multiple companies at the same way, the way that venture capital firms have been doing through the use of capital, it follows that the software engineer would have a higher probability of receiving a return on investment from diversifying their contributions across several software startups, similar to how venture capital firms have been doing.

Until now, no software engineer has figured out how to diversify to the same extent as venture capital firms or even realized that this is a problem. Further, the majority of software engineers do not not recognize that this is even a problem to be solved. Venture capital firms have the advantage through diversification, why not software engineers?

### BRIEF SUMMARY OF THE INVENTION

So to summarize, there are two parties, each with one challenge each.
software engineers with the challenge of investment diversification.
non-technical founders of software startups with the challenge of having software to sell.

This invention solves investment diversification for software engineers through the business method of using Software as Venture Capital. This invention also solves non-technical co-founders having software to sell.

### DETAILED DESCRIPTION OF THE INVENTION

FIG. 1.

Depicts the current state of the art for venture capital firms' diversification strategy, investing in different software startups. Each startup attempts to produce software. The grey ‘x’ indicates software does not function, is not used, has no market, or in other words does not generate revenue. This figure models reality in the sense that the majority of investments lose money (indicated in red), a few companies break even (indicated in orange) and even fewer companies give a return on investment (indicated in green).

FIG. 2.

Depicts the non-obvious business method in this patent—software as venture capital. FIG. 2 is similar to FIG. 1 in the sense that the diversification strategy is the same (investing in a variety of different software startups). However, FIG. 2 is different from FIG. 1, because the Venture Software Firm supplies software directly to each company (as indicated below), as opposed to cash. The outcome of FIG. 1 and FIG. 2 are the same, a diversified investment strategy with most investments providing no return (indicated in red), some investments breaking even (indicated in orange), and still fewer investments providing a return on investment (indicated in green).

FIG. 3.

Depicts a more granular view of a single company within FIG. 1. This is the current state of the art business method and accounts for unpaid labor of software engineers. Arrow #1 demonstrates how cash from a venture capital firm funds a company. Arrow #2 demonstrates how software engineers' salaries are funded with cash. The second arrow also indicates how the company convinces software engineers to work above and beyond what they have been paid for, in exchange with the addition of ownership in the company (e.g stock options). Arrow #3 indicates the bifurcation of equity paid from the software engineer to the company and the venture capital firm. Arrow #4 indicates the bifurcation of return on investment that the software in the marketplace provides to the company and venture capital firm.

FIG. 4.

Depicts a more granular view of FIG. 2 for a single company. The Venture Software Firm provides the startup company with software (indicated by arrow #1). In exchange for the software, the company grants the Venture Software Firm equity in their company and pays for the software. Note that the company has no software engineer employees to pay or grant equity to. Next, arrow #3 indicates the Venture Software Firm launching software into the marketplace. Finally, arrow #4 is bifurcated between the Venture Software Firm and the company, if the software returns any cash.

FIG. 5.

Depicts a concrete use-case of how a Venture Software Firm could be used in Telemedicine. This figure is not meant to limit the scope of this patent. FIG. 5 shows a Venture Software Firm's server deploying both general and industry specific software functionality in telemedicine. For example, general functionality includes login and registration. Telemedicine niche-specific functionality includes but is not limited to e-prescription, scheduling and video chat. FIG. 5 has already been reduced to practice and can be viewed at doctorsintech.com

As seen in this figure, the Venture Software Firm (DOCTORS IN TECH®) provides several startup telemedicine companies with similar software features through the server API, and several companies have their branded technology appearing through the client API.

The ‘Venture Software Firm’ produces and distributes the software requested directly to the non-technical co-founder company, and the non-technical co-founder exchanges in return some kind of equity, ownership, monthly fee, and/or immediate royalties for software sold. This business method solves two business challenges: diversification for software engineers, and non-technical founders having software.

How do you solve software engineer investment diversification specifically, while also providing non-technical founders with the software they need? How could any engineer turn themselves from a single contributor into a diversified investment contributor on a much larger scale? How can a single software engineer use Software as Venture Capital to help more startups in the same amount of time? Here is how.

The software engineer needs to:

1. Understand and identify which functionality is mostly the same across software startups in a particular industry

2. Create a client based API that can perform that functionality for the front-end from step #1.

3. Create a server based API that can perform that functionality on the server from step #1.

If done correctly, the software engineer identifies that somewhere around 80% of the functionality between software within a space is exactly the same, a smaller percentage is mostly the same, and only a very small percentage of functionality is widely different. By completing these steps the software engineer finds that the amount of effort to create a new software startup for a different company is minimal. If 80% of functionality can be correctly identified, created, and distributed, that means only 20% of labor would be required to get the startup company from point a to point B with their software. That means that a single software engineer could contribute to a total of 5 projects, if they decided to work 100% of the time. If the software engineer is able to identify more than 80% similarity between companies in their industry vertical, they could scale and diversify their participation in a variety of companies even further.

As a side-effect, the time it takes for the non-technical co-founder to have their software built is also reduced, because an estimated 80%+ is already ready to go right now. The new business method model is more efficient, does not use capital. It sounds good, but can it actually be done. Is a software engineer capable of discovering common patterns within an industry vertical. The answer is Yes. Ian Sharp PhD has achieved this and reduced this model to practice for a specific use-case. Therefore it is reasonable that others could do the same.

To help the reader understand further, that this is actually possible, here is a concrete use-case, which is in no way indicated to reduce the scope of this business method invention.

Use-Case:

Telemedicine is an area of venture capital that is invested in right now.

1. Identified where the majority of functionality is the same
login, registration, hipaa compliance, calendar scheduling, video chat services, e-prescription services, and electronic health records

2. create client API

3. create server API

This business method and a concrete use-case for telemedicine, ‘Software as Venture Capital’ has already been reduced to practice and is being used to diversify contribution to more than one software company at the same time on https://doctorsintech.com

### DRAWINGS

FIGS. 1 through 4 indicate the state of the art and the novel business method proposed in this patent, while FIG. 5 depicts a concrete use-case. FIG. 5 is meant to help the reader understand how the Software as Venture Capital method can be accomplished, while in no way reducing or restricting the claim to this specific use-case of Telemedicine.

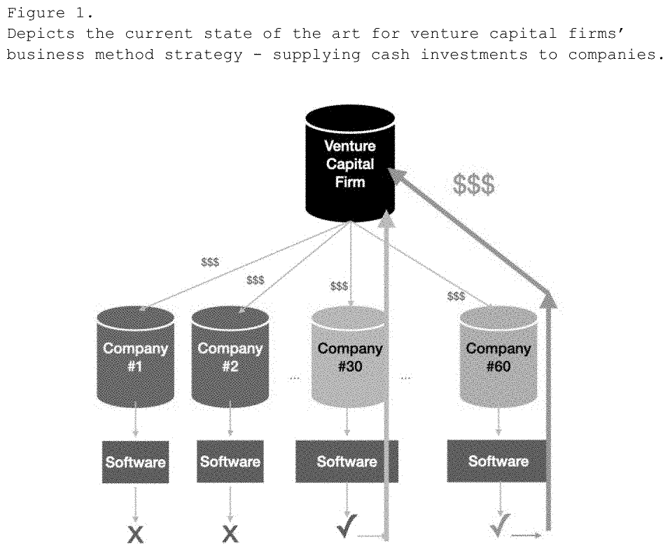

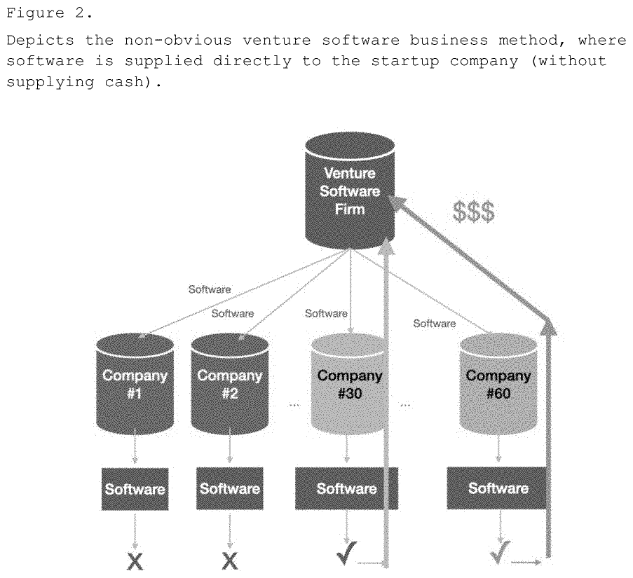

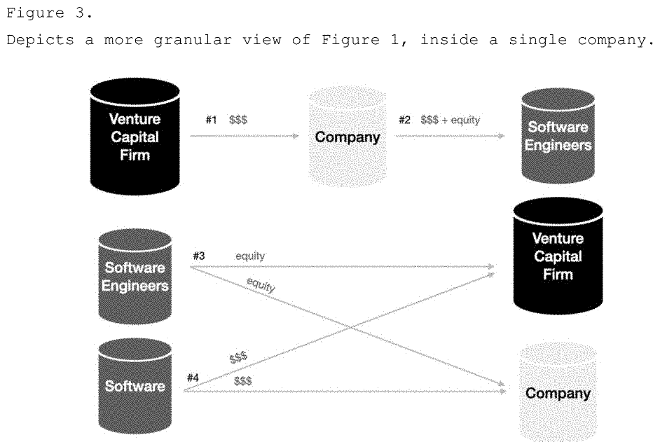

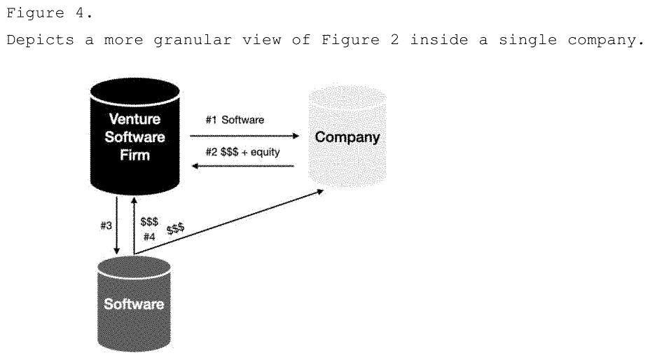

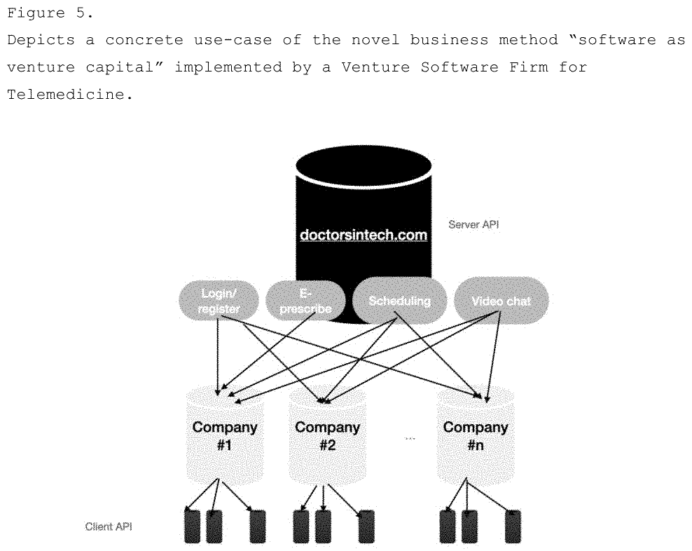

### Claims

1. Software as Venture Capital
2. How to create a Venture Software Firm
3. How software engineers can diversify investment across multiple startups at the same time, without the use of cash

1. Software as Venture Capital

2. How to create a software venture capital firm

3. How software engineers can diversify investment across multiple startups at the same time, without the use of cash
